(19) United States
(12) Patent Application Publication
(10) Pub. No.: US 2012/0047167 A1
(43) Pub. Date: Feb. 23, 2012

(54) PORTABLE TERMINAL

(75) Inventors: Masaki SAKAI, Tokyo (JP); Natsuko OUCHI, Kawasaki (JP)

(73) Assignee: FUJITSU TOSHIBA MOBILE COMMUNICATIONS LIMITED, Kawasaki-shi (JP)

(21) Appl. No.: 13/287,857

(22) Filed: Nov. 2, 2011

Related U.S. Application Data
(63) Continuation of application No. PCT/JP2010/051031, filed on Jan. 27, 2010.

(30) Foreign Application Priority Data
May 18, 2009 (JP) 2009-119988

(51) Int. Cl. G06F 17/30

(52) U.S. Cl. 707/769; 707/E17.022

(57) ABSTRACT

A portable terminal includes a word extracting unit that extracts a word contained in data of a Web page being viewed; a Web search request unit that transmits a search request to a search site with the word extracted by the word extracting unit as a search word and that receives a list of Web pages that contain the search word from the search site as a search result; and a display unit that displays the search result received by the Web search request unit.

### CROSS-REFERENCE TO RELATED APPLICATIONS

This application is a U.S. continuation application filed under 35 USC 111(a) claiming benefit under 35 USC 120 and 365(c) of PCT application JP2010/051031, filed on Jan. 27, 2010, which claims priority to Application Ser. No. 2009-119988, filed in Japan on May 18, 2009, the disclosure of which is hereby incorporated by reference.

### FIELD

The disclosure herein relates to portable terminals capable of viewing Web pages. More specifically, the disclosure relates to portable terminals capable of easily conducting a Web search by using words or phrases contained in a Web page currently being viewed.

### BACKGROUND

In recent years, communications network infrastructure has been improved greatly due to the development of communications technologies, enabling smooth communication of data using portable terminals such as portable telephones. At the same time, access to Web sites from portable terminals has increased. However, a user may not conduct a Web search easily by using a word or phrase contained in a Web page currently being viewed from his or her portable terminal. When using PCs (Personal Computers) and other devices that do not have too many operational limitations, a user can easily conduct a Web search by using a multi-functional browser, for example. Portable terminals, however, are more functionally limited. Thus, when conducting a Web search from a portable terminal, the user needs to perform a number of operations step by step. Even after such time-consuming operations, a desired search result may not be necessarily obtained.

Japanese Laid-open Patent Publication No. 2001-229198 discusses a Web page search system designed to enable easy access to a target Web page. In this Web page search system, plural items of information including a keyword portion and an address portion are stored in a server. In the keyword portion, unique keywords are stored, and a name of a search engine and a keyword are advertised. When a search is conducted by inputting the keyword into the search engine, the search engine searches for a corresponding information record and causes the content of a Web page whose address is stored in the address portion of the information record to be displayed on a display.

### SUMMARY

According to one aspect of the invention, there is provided a portable terminal including a word extracting unit configured to extract a word contained in data of a Web page being viewed; a Web search request unit configured to transmit a search request to a search site with the word extracted by the word extracting unit as a search word and receive a list of Web pages that contain the search word from the search site as a search result; and a display unit configured to display the search result received by the Web search request unit.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a perspective view of a network system in which a portable terminal (portable telephone) according to a first embodiment is applied;

FIG. 2 is a perspective view of the portable terminal according to the first embodiment;

FIG. 3 is a block diagram of the portable terminal;

FIGS. 4A and 4B illustrate screens displayed on a touch screen of the portable terminal during a Web search process;

FIG. 5 is a sequence diagram of the Web search process performed by the portable terminal according to the first embodiment;

FIGS. 6A through 6E illustrate screens displayed on the touch screen of the portable terminal during the Web search process according to the first embodiment;

FIG. 7 is a sequence diagram of a Web search process performed by the portable terminal according to a second embodiment;

FIGS. 8A through 8D illustrate screens displayed on the touch screen of the portable terminal during the Web search process according to the second embodiment;

FIG. 9 is a sequence diagram of a Web search process performed by the portable terminal according to a third embodiment;

FIGS. 10A through 10D illustrate screens displayed on the touch screen of the portable terminal during the Web search process according to the third embodiment;

FIG. 11 is a sequence diagram of a Web search process performed by the portable terminal according to a fourth embodiment;

FIGS. 12A through 12C illustrate screens displayed on the touch screen of the portable terminal during the Web search process according to the fourth embodiment; and

FIG. 13 is a functional block diagram of a main control unit of the portable terminal according to an embodiment.

### DESCRIPTION OF EMBODIMENTS

As described previously, when the search is conducted by inputting the keyword into the search engine, the search engine may search for the corresponding information record and cause the content of the Web page whose address is stored in the address portion of the information record to be displayed on a display. However, when a user attempts to conduct a Web search from his or her portable terminal, even if a search target word is contained in a Web page currently being viewed, a Web search may not be started from the Web page currently being accessed by directly using the search word. Instead, the user needs to open another search site and either enter the search word into an input field letter by letter, or copy the word from the currently accessed Web page and then paste it in the input field of the search site. Such operations put much operational burden on the user.

Preferred embodiments of the present invention will be explained with reference to accompanying drawings.

### [a] First Embodiment

A portable terminal according to a first embodiment is described with reference to the attached drawings. A portable telephone 1, which is an example of a portable terminal, includes a display that enables input of data by detecting contact of a user's finger, for example. Based on the input via the display, a Web page can be accessed or viewed.

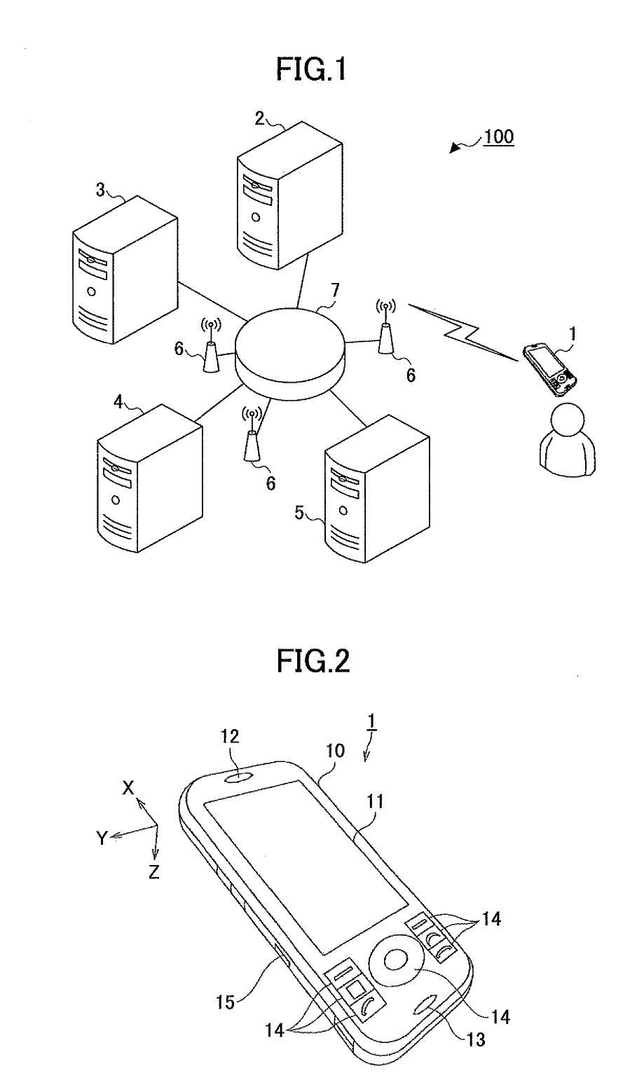

FIG. 1 illustrates a network system 100 in which the portable telephone 1 is applied. The network system 100 includes at least the portable telephone 1, a content server 2, a first interest orientation search server 3, a second interest orientation search server 4, a word-of-interest extension/inquiry server 5, base stations 6, and a network 7.

The content server 2 stores page data (content) of a number of Web pages. The content server 2 extracts page data in response to a transmit request from a client (such as the portable telephone 1) and supplies the extracted page data to the client. For example, upon designation of an address by the client at which certain page data is stored, the content server 2 extracts the page data stored at the designated address and supplies the page data to the client.

The first interest orientation search server 3 and the second interest orientation search server 4 store a number of words or phrases in association with Web pages that contain the words or phrases (search words). Upon reception of a search request from a client, these search servers extract one or more Web pages corresponding to a search word received together with the search request, and supply a data list concerning the Web pages to the client. Preferably, the first interest orientation search server 3 and the second interest orientation search server 4 may be coordinated with another search server so that the first or second interest orientation search server 3 or 4 can request a search from the other search server, acquire a search result from the other server, and then supply the search result to the client.

The search servers including the first interest orientation search server 3 and the second interest orientation search server 4 may provide various search sites. Examples include a general search site that searches for Web pages containing the search word, a dictionary search site that searches for Web pages explaining meanings or usages of the search word, a shopping search site that searches for Web pages selling products related to the search word on the Internet, and a video search site that searches for video sites providing videos related to the search word. These search sites may include a community site that enables a number of users to mutually provide information.

The word-of-interest extension/inquiry server 5 serves as an intermediary between the portable telephone 1 and a search server when the portable telephone 1 conducts a Web search. For example, upon reception of a search word from the portable telephone 1, the word-of-interest extension/inquiry server 5 extends the search word and narrows or determines an interest orientation (i.e., the search server to which the search request is transmitted) before transmitting the search request to the search server. Upon reception of a search result from the search server, the word-of-interest extension/inquiry server 5 transmits the search result to the portable telephone 1. When extending the word of interest, the word-of-interest extension/inquiry server 5 may add another word or phrase to the received word of interest or narrow the interest orientation in view of a utilization history or profile information of the user of the portable telephone 1 or the current social conditions. The added word or phrase or the narrowed interest orientation may be set by the user in advance.

The base stations 6 are fixed wireless stations set up in cells of desired sizes dividing a wireless communications service providing area within the network system 100. The portable telephone 1, which is a mobile wireless station, may be wirelessly connected to the base stations 6 via a code division multiple access technology called “W-CDMA (Wideband-Code Division Multiple Access)”. The portable telephone 1 may be wirelessly connected to the network 7 via the nearest one of the base stations 6 in order to perform communications with the content server 2 or the first interest orientation search server 3, for example.

The network 7 may include a portable telephone network, the Internet, a LAN (Local Area Network), a WAN (Wide Area Network), or various other types of network, either individually or in combination. The portable telephone 1 communicates with various servers, such as the content server 2 and the first interest orientation search server 3, via the network 7.

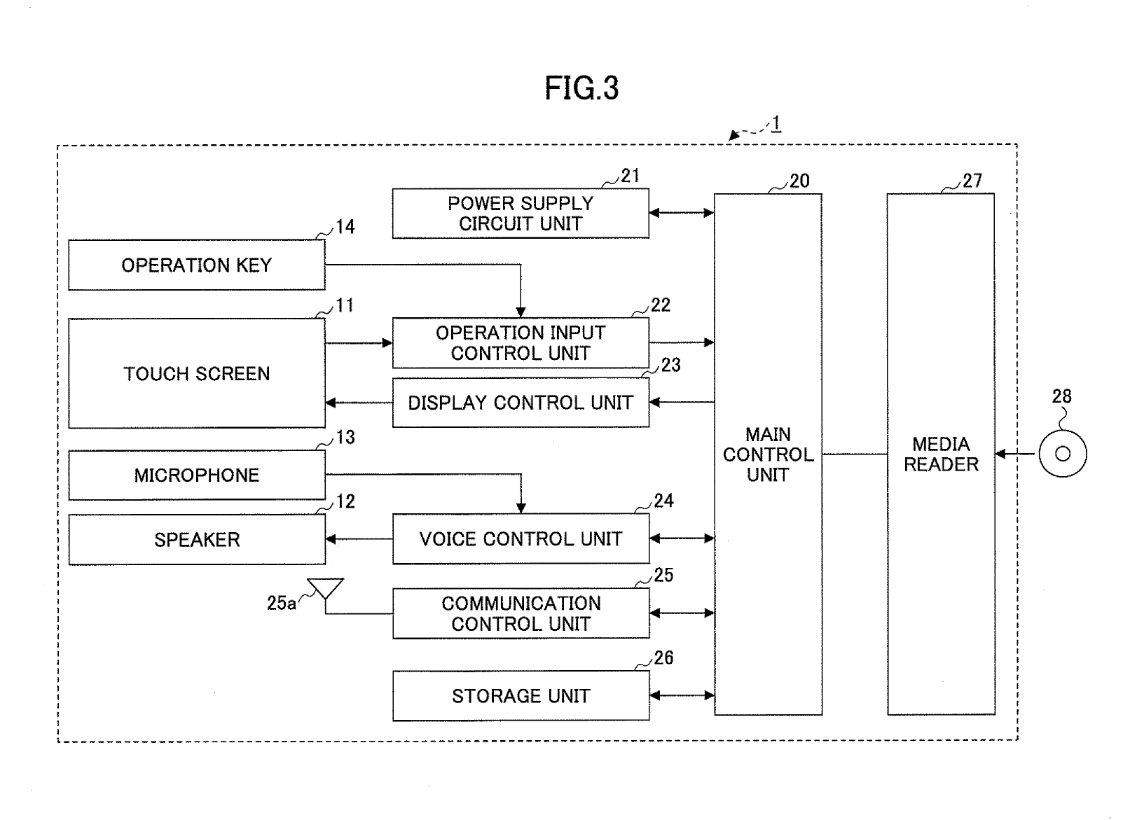

FIG. 2 is a perspective view of the portable telephone 1. The portable telephone 1 includes a casing 10 having a rectangular plate shape. On a surface of the casing 10, there are provided a touch screen 11 that displays data and also enables data input by touching the surface of the touch screen 11; a speaker 12 for outputting voice; a microphone 13 for inputting voice; and plural operation keys 14 that may be depressed for inputting various instructions. The term “voice” may refer to not only human voice but also other audible sounds.

The touch screen 11 is a display having both a display function and an input function. The display function displays data, such as characters and images. The input function may enable the input of various instructions by detecting a position of contact where a user has touched the touch screen 11 with a finger or a special pen. The touch screen 11 may include plural elements arranged on the surface of the display for detecting contact, with a transparent screen laminated on the elements. A touch on the touch screen 11 may be detected by various methods, including a pressure-sensing method that senses a change in pressure, and an electrostatic method that senses an electric signal due to static electricity.

The operation keys 14 may include a direction key for moving a cursor displayed on the touch screen 11 up and down or left and right or for scrolling the screen, a call key for making a telephone call, a call-terminating key for terminating a call, and a short-cut key for starting up a mail function or a Web function.

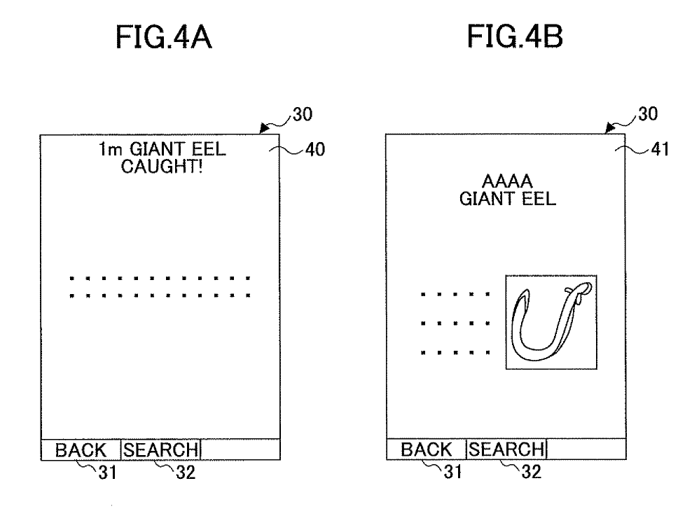

FIG. 3 is a hardware block diagram of the portable telephone 1. As illustrated in FIG. 3, the portable telephone 1 includes a main control unit 20, a power supply circuit unit 21, an operation input control unit 22, a display control unit 23, a voice control unit 24, a communication control unit 25, and a storage unit 26, which are connected by a bus such that they can communicate with one another.

The main control unit 20, which may include a CPU (Central Processing Unit), generally controls the portable telephone 1. The main control unit 20 may also perform various processes, such as a Web search request process, a calculation process, and a control process, as will be described later.

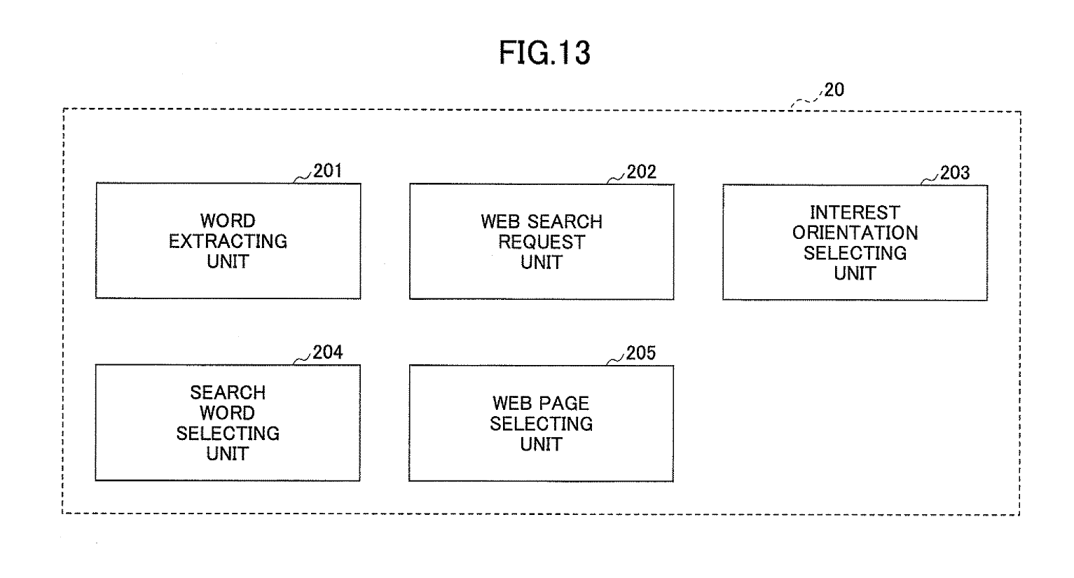

FIG. 13 is a functional block diagram of various units of the main control unit 20 for realizing various processes such as those mentioned above. Specifically, the main control unit 20 includes a word extracting unit 201, a Web search request unit 202, an interest orientation selecting unit 203, a search word selecting unit 204, and a Web page selecting unit 205.

The power supply circuit unit 21 includes a power supply (such as a battery). Based on an input via a predetermined one of the operation keys 14, the on- and off-states of the portable telephone 1 may be switched. When the portable telephone 1 is in the on-state, the power supply circuit unit 21 supplies electric power to the various units of the portable telephone 1, thus enabling the portable telephone 1 to operate.

The operation input control unit 22 includes an input interface for the touch screen 11. Upon detection of contact on the touch screen 11, the operation input control unit 22 generates a signal indicating the position of contact and sends the signal to the main control unit 20. The operation input control unit 22 also includes an input interface for the operation keys 14. Upon depressing of any of the operation keys 14, the operation input control unit 22 generates a signal indicating the depressed key and sends the signal to the main control unit 20. Upon reception of the signals, the main control unit 20 performs various processes based on the signals. The display control unit 23 includes a display interface for the touch screen 11. The display control unit 23 generates display screen data under the control of the main control unit 20 and causes the touch screen 11 to display the display screen data.

The voice control unit 24, under the control of the main control unit 20, generates an analog voice signal from voice sound waves collected by the microphone 13, and converts the analog voice signal into a digital voice signal. The voice control unit 24, upon acquisition of the digital voice signal, converts the digital voice signal into an analog voice signal under the control of the main control unit 20, and causes the speaker 12 to output the analog voice signal as voice sound waves.

The communication control unit 25, under the control of the main control unit 20, may recover data by subjecting a reception signal received from the base stations 6 via an antenna 25a to a spectrum inverse diffusion process. In accordance with an instruction from the main control unit 20, the recovered data may be transferred to the voice control unit 24 for output via the speaker 12 or the display control unit 23 for display on the touch screen 11, or recorded in the storage unit 26. Upon acquisition of either voice data collected by the microphone 13, data input via the touch screen 11 or the operation keys 14, or data stored in the storage unit 26, the communication control unit 25 may subject such data to a spectrum diffusion process under the control of the main control unit 20 before transmitting the data to the base stations 6 via the antenna 25a.

The storage unit 26 may include a ROM (Read Only Memory) or a hard disk for storing a processing program for a process executed by the main control unit 20 and data for the process, a non-volatile memory, and a RAM (Random Access Memory) for temporarily storing data used by the main control unit 20 when executing a process. A processing program executed by the main control unit 20 for performing a Web search process (as will be described later) may be stored in the ROM. Preferably, a processing program stored in an external recording medium 28 may be read by a media reader 27 and loaded in a memory by the main control unit 20.

The portable telephone 1 has functions for acquiring page data for a Web page from the content server 2 via the network 7 and displaying the Web page on the touch screen 11. The portable telephone 1 also has functions for transmitting a search request and a search word to a search site provided by a search server, such as the first interest orientation search server 3 or the second interest orientation search server 4, receiving a search result from the search server, and displaying the search result on the touch screen 11.

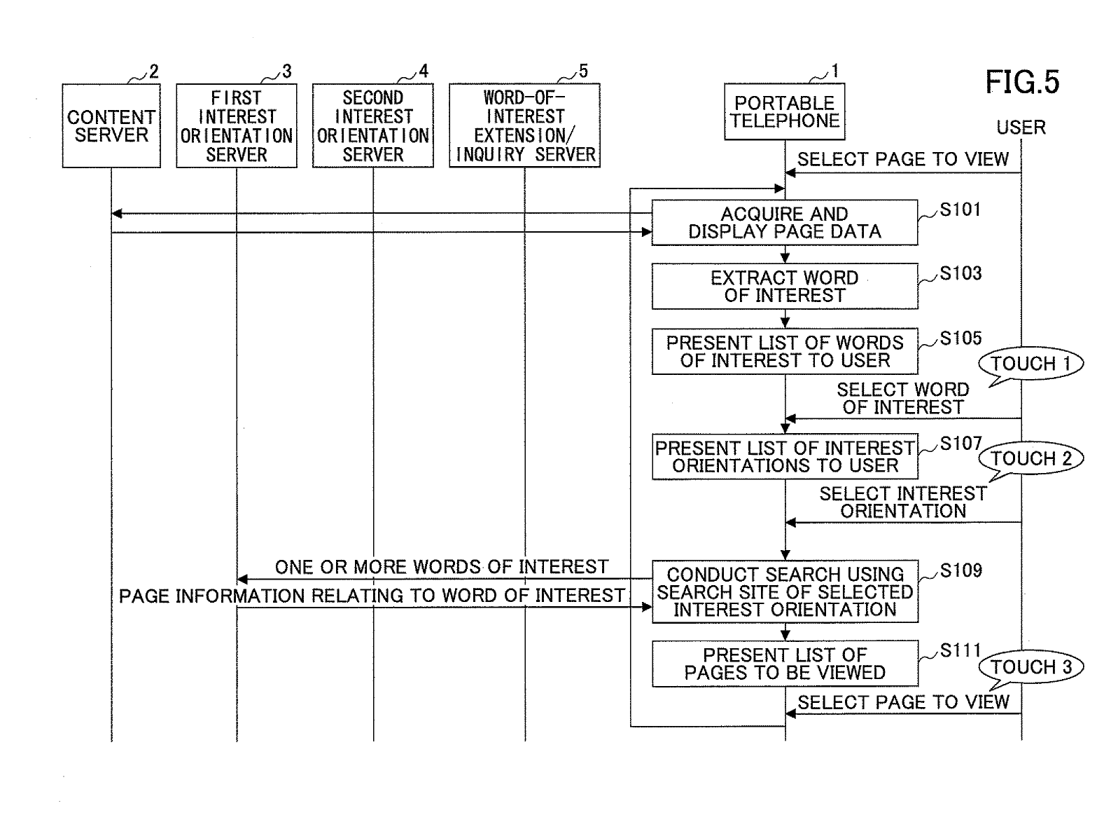

FIGS. 4A and 4B illustrate the transition of screens on the touch screen 30 of the portable telephone 1 during a Web search process. FIG. 4A illustrates an example of a display screen 30 displayed on the touch screen 11 when the portable telephone 1 is displaying a viewing screen 40 for a Web page. FIG. 4B illustrates an example of the display screen 30 on the touch screen 11 displaying a search result screen 41 after a search has been conducted by the portable telephone 1 based on the viewing screen 40 illustrated in FIG. 4A.

When the portable telephone 1 is displaying Web page information acquired from the content server 2 on the touch screen 11 as illustrated in FIG. 4A, the display screen 30 displays a back button 31 for displaying a previous page and a search button 32 for conducting a Web search. Preferably, the back button 31 or the search button 32 may be tied to an arbitrary operation key 14 instead of being displayed on the touch screen 11. The displayed Web page contains a news article “1 m giant eel caught!”, for example. In this case, the user viewing the news article may wish to conduct a Web search by using a word or phrase contained in the news article.

In a conventional portable terminal, a Web search is conducted by using a word or phrase (such as “giant eel”) designated by the user as a search target word (search word). Then, a Web page containing data about “giant eel” may be received as a search result and displayed as illustrated in FIG. 4B. In this case, even if the search word “giant eel” is contained in the Web page being viewed, the user first needs to open a search Web page on the touch screen 11 and then input the word “giant eel” into an input field of the search Web page by using the touch screen 11 or the operation keys 14. The series of operations puts much burden on the user.

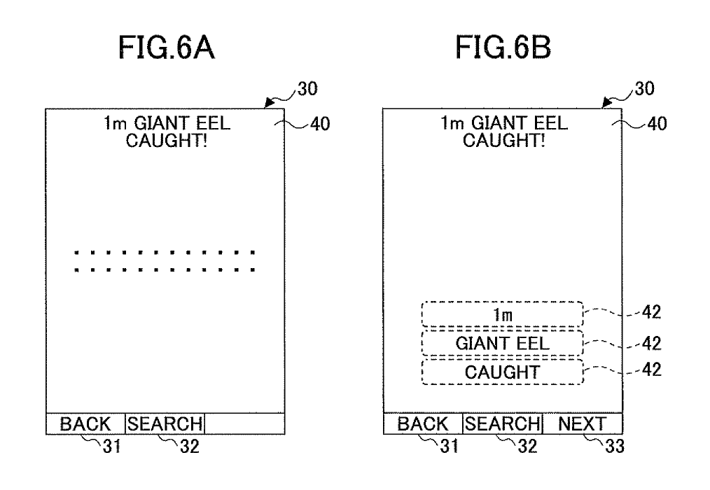

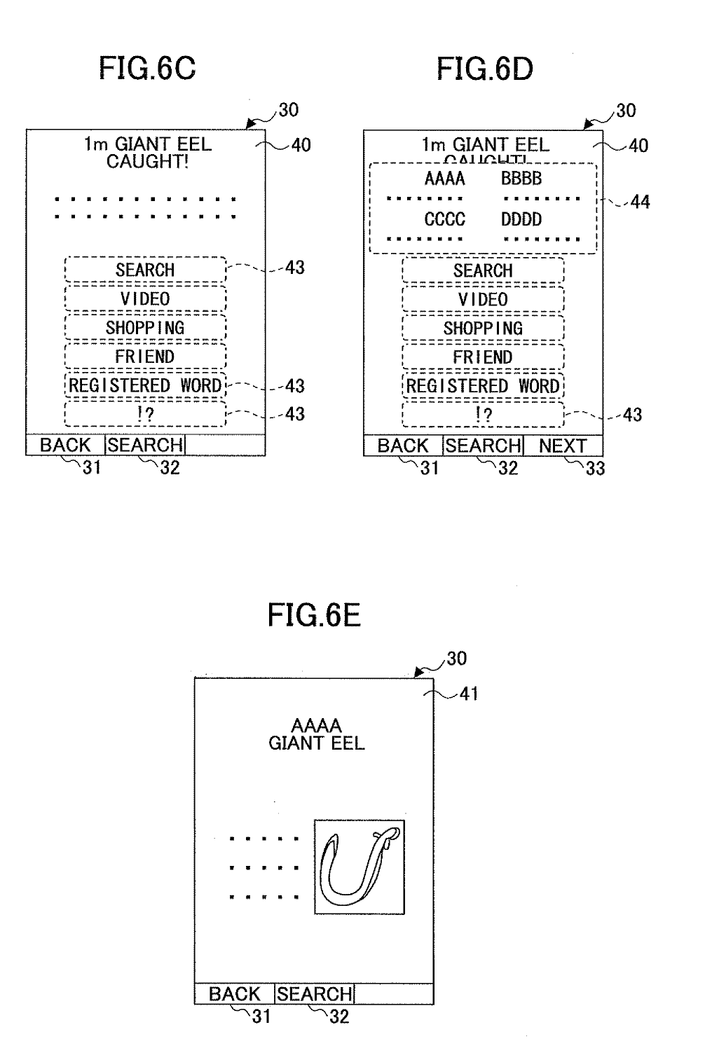

In accordance with the present embodiment, the portable telephone 1 has a Web function that enables a Web search by a simple operation performed by the user during the viewing of a Web page. Specifically, words and phrases that may be searched by the user are extracted from the Web page in the background, i.e., while the Web page is being displayed on the touch screen 11. Thus, a Web search can be conducted immediately by using an extracted word or phrase upon instruction from the user, and search results can be presented to the user quickly. Such a Web search process performed by the portable telephone 1 will be described with reference to a sequence diagram of FIG. 5 and FIGS. 6A through 6E illustrating the transition of screens on the touch screen of the portable telephone 1 during the Web search process.

First, the portable telephone 1 presents a list of Web pages as viewing targets to the user and prompts the user to select a desired Web page. Upon selection of a Web page by the user, the main control unit 20 transmits a transmit request for page data of the selected Web page to the content server 2. The content server 2 transmits the requested page data to the portable telephone 1. The portable telephone 1 receives the page data from the content server 2. The main control unit 20 causes the touch screen 11 to display the received page data (S101 in FIG. 5). For example, as illustrated in FIG. 6A, the Web viewing screen 40 is displayed on the display screen 30 of the touch screen 11, displaying a Web page containing the news article “1 m giant eel caught!”.

While the Web page is being displayed on the touch screen 11, the main control unit 20 extracts one or more words of interest from the page data of the Web page (S103). The words of interest may include arbitrary words for which a Web search can be conducted. For example, the main control unit 20 extracts the words of interest by performing a morphological analysis for distinguishing words. Preferably, the main control unit 20 may extract nouns immediately before or after certain grammatical parts, such as verbs “is” and “are”, prepositions “at”, “in”, and “of”, or particles. In this case, the main control unit 20 provides the word extracting unit 201 illustrated in FIG. 13.

The main control unit 20 then displays a list of words of interest on the touch screen 11 and prompts the user to select one or more of the words of interest (S105). For example, from the news article “1 m giant eel caught!” contained in the Web page, words such as “1 m”, “giant eel”, and “caught” are extracted as words of interest, as illustrated in FIG. 6B. The words are then displayed on the display screen 30 of the touch screen 11 as words of interest buttons 42. The user then selects any of the words of interest by touching a desired one of the words of interest buttons 42 on the touch screen 11 with a finger.

The selected word of interest is subsequently transmitted to a search site as a search word together with a search request. Thus, in this case, the main control unit 20 provides the search word selecting unit 204 illustrated in FIG. 13.

The extracted words of interest may be displayed by methods other than as the words of interest buttons 42. For example, the extracted words of interest may be indicated by a marker, anchor text, or highlight on the Web page, so that a word of interest can be selected when the user touches a word or phrase in the Web page.

When the word of interest is selected, the main control unit 20 causes a list of interest orientations to be displayed on the touch screen 11, and prompts the user to select one of the interest orientations (S107). For example, as illustrated in FIG. 6C, pre-set interest orientations stored in the storage unit 26 include “search”, “video”, “shopping”, “friend”, “registered word”, and “!?”, and they are displayed on the display screen 30 of the touch screen 11 as interest orientation buttons 43. The user then selects one of the interest orientations by touching a desired one of the interest orientation buttons 43 on the touch screen 11 by a finger. In this case, the main control unit 20 provides the interest orientation selecting unit 203 illustrated in FIG. 13.

When “search” is selected as the interest orientation, a search request is issued to a search site whose main search targets include general Web pages containing the search word and dictionary sites. When “video” is selected as the interest orientation, a search request is issued to a search site whose main search targets include video sites containing the search word. When “shopping” is selected as the interest orientation, a search request is issued to a search site whose main search targets include Internet shopping sites containing the search word.

When “friend” is selected as the interest orientation, a search request is issued to a community site that enables a number of users to mutually provide information, and user pages with user names or user nicknames corresponding to the search word are searched. When “registered word” is selected as the interest orientation, the search word (such as “giant eel”) is associated with a predetermined word (such as “recipe”) registered in advance, and a search request is issued to a search site by using all of the associated words (“giant eel” and “recipe”) as the search words. The predetermined word or phrase may be input by the user and then stored in the storage unit 26. When “!?” is selected as the interest orientation, a search request is issued to a specific server set in advance. From the specific server, current social issues relating to the search word may be extracted as search results.

The interest orientation buttons 43 may be displayed at all times when viewing a Web page (such as whenever a Web page is updated). Alternatively, the interest orientation buttons 43 may be displayed when the user touches the search button 32 or operates a predetermined one of the operation keys 14. Preferably, when selection of the interest orientation is made once, the selected interest orientation may be made valid thereafter, so that the subsequent selection of the interest orientation by the user can be omitted and the display of the interest orientation buttons 43 can be disabled.

The main control unit 20, with respect to the word of interest selected in step S105, conducts a Web search by using a search site suitable for the interest orientation selected in step S107 (S109). Namely, the main control unit 20 transmits the word of interest selected in step S105 (i.e., a search word) to the search site suitable for the interest orientation selected in step S107 (such as the first interest orientation search server 3, which may be a search server that mainly searches a dictionary site), together with a search request. The first interest orientation search server 3, for example, then conducts a search using the received word of interest, extracts Web pages that contain the word of interest, and transmits a list of the Web pages to the portable telephone 1 as a search result.

Thus, the main control unit 20 provides the Web search request unit 202 of FIG. 13.

Upon reception of the Web page list by the portable telephone 1, the main control unit 20 causes the Web page list to be displayed on the touch screen 11 and prompts the user to select a Web page to view (S111). For example, as illustrated in FIG. 6D, data concerning Web pages “AAAA”, “BBBB”, “CCCC”, and “DDDD” in the received Web page list are displayed on the display screen 30 of the touch screen 11 as a Web page button 44. The user then selects one of the Web pages by touching a desired Web page from the Web page button 44 on the touch screen 11. Upon selection of a Web page, the main control unit 20 receives the page data of the Web page from the content server 2 and causes the Web page to be displayed on the touch screen 11. In this case, the main control unit 20 provides the Web page selecting unit 205 illustrated in FIG. 13.

For example, when the user has selected “giant eel” in step S105, “search” in step S107, and the Web page “AAAA” after step S111, the portable telephone 1 acquires the page data of the Web page “AAAA”, and causes the Web page to be displayed on the display screen 30 of the touch screen 11 as the search result screen 41, as illustrated in FIG. 6E. Thus, the portable telephone 1 can display a list of Web pages as view targets on the touch screen 11 in a compact manner, so that the user can easily select a Web page by simply touching the touch screen 11.

In FIG. 6D, the interest orientation buttons 43 and the Web page button 44 are displayed. In this state, when the user selects any of the interest orientation buttons 43, the portable telephone 1 may conduct a search (process of step S109) again based on the selected interest orientation, and present newly obtained search results in the Web page button 44. For example, in the state of FIG. 6D, when the user selects the interest orientation button 43 for “video”, the portable telephone 1 sends a search request to a video search site, and presents video sites in the Web page button 44.

Thus, the portable telephone 1 transmits the word of interest selected by the user as a search word to the search server corresponding to the interest orientation selected by the user, receives search results from the search server, and then displays the search results on the touch screen 11. The user then selects a desired Web page from the search results obtained based on the search word and the search orientation selected by the user. Thus, the user can narrow the word of interest by himself, so that the probability of successfully obtaining relevant search results sought by the user can be increased, and the time for the search process can be reduced.

Preferably, when a Web page is displayed on the touch screen 11, the words of interest buttons 42 or the interest orientation buttons 43 may be displayed at all times. Alternatively, the words of interest buttons 42 or the interest orientation buttons 43 may be displayed based on an operation by the user on the touch screen 11 or via the operation keys 14. When the words of interest buttons 42 or the interest orientation buttons 43 are displayed at all times, display of such buttons may be disabled when the user touches the Web page (or a portion of the Web page where none of the buttons are displayed). In this case, the display of the words of interest buttons 42 or the interest orientation buttons 43 may be resumed when the user performs an operation on the touch screen 11 or via the operation keys 14.

In the foregoing description of the first embodiment, the word of interest is selected (process of step S105) first and then the interest orientation is selected (process of step S107). However, this is merely an example; preferably, the word of interest may be selected after the interest orientation is selected.

In accordance with the first embodiment, the user can easily conduct a Web search by using a word or phrase contained in a Web site the user is currently viewing.

### [b] Second Embodiment

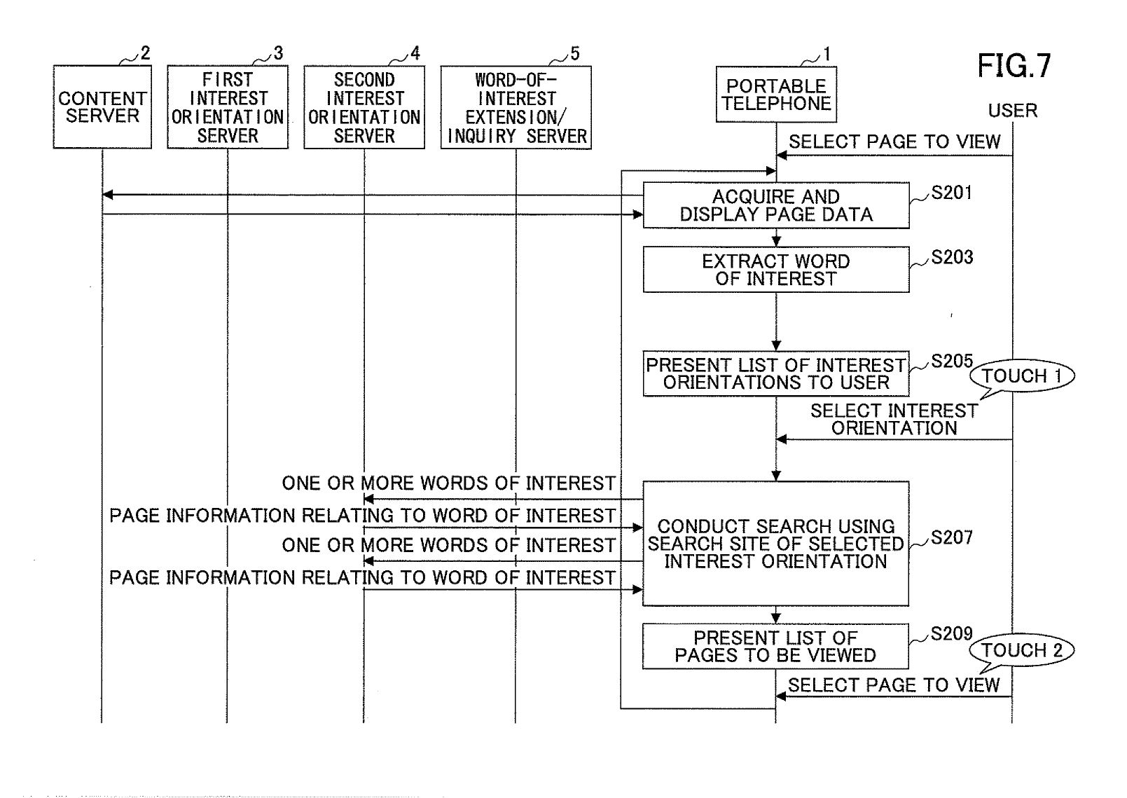

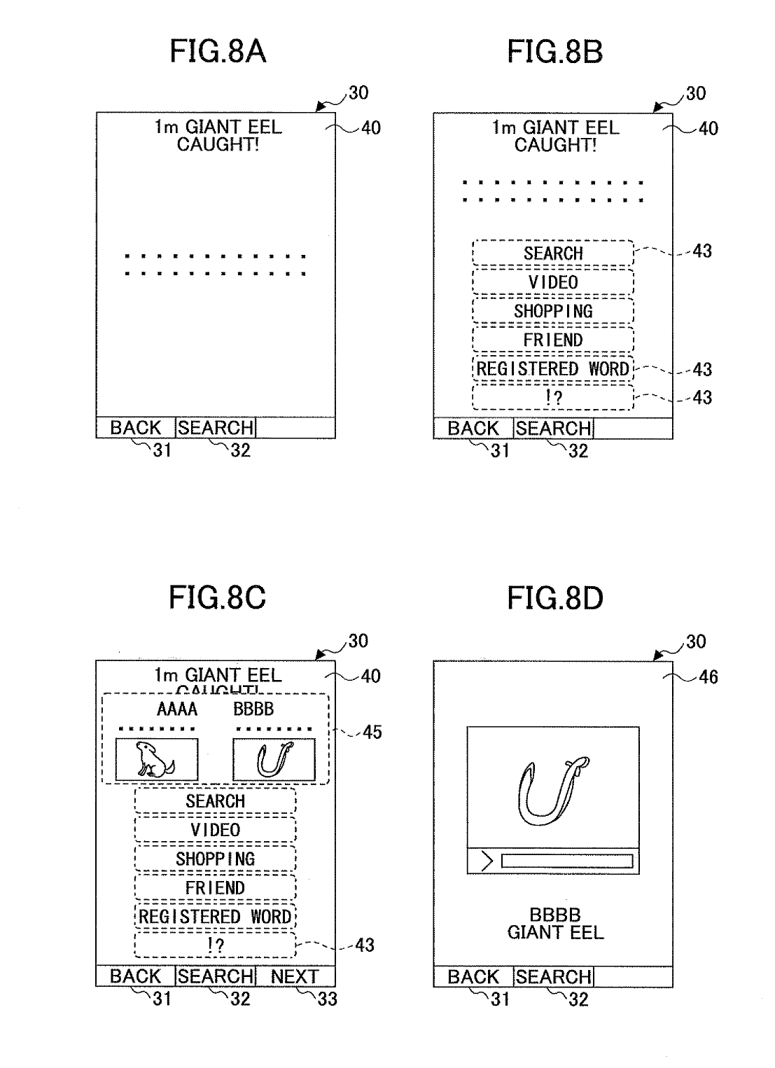

A portable terminal according to a second embodiment is described with reference to FIGS. 7 and 8. In the following description, elements similar to those of the first embodiment are designated with similar reference numerals in order to omit redundant descriptions. The portable telephone 1, which is an example of a portable terminal, according to the second embodiment may be applied in the same network system 100 illustrated in FIG. 1 as that of the first embodiment. Also, the portable telephone 1 according to the second embodiment may have the same structure as that of the first embodiment illustrated in FIG. 2. Further, the portable telephone 1 according to the second embodiment may include the same units as those of the first embodiment illustrated in FIG. 3; namely, the main control unit 20, the power supply circuit unit 21, the operation input control unit 22, the display control unit 23, the voice control unit 24, the communication control unit 25, and the storage unit 26, which are connected to one another via a bus so that they can mutually communicate with each other.

In the first embodiment, the portable telephone 1 allows the user to select both the word of interest and the interest orientation in order to start a Web search during the viewing of a Web page. In the second embodiment, the portable telephone 1 allows the user to select only the interest orientation and not the word of interest, so that the operational burden on the user for a Web search can be reduced.

A Web search process performed by the portable telephone 1 according to the second embodiment is described with reference to a sequence diagram of FIG. 7 and FIGS. 8A through 8D illustrating the transition of screens on the touch screen of the portable telephone 1 during the Web search process.

First, the portable telephone 1 presents a list of Web pages as view targets to the user and prompts the user to select a desired Web page. When the user selects a Web page, the main control unit 20 transmits a transmit request for the page data of the selected Web page to the content server 2. The content server 2 transmits the requested page data to the portable telephone 1. The portable telephone 1 receives the page data from the content server 2. The main control unit 20 also displays the received page data on the touch screen 11 (S201). For example, as illustrated in FIG. 8A, the Web viewing screen 40 is displayed on the display screen 30 of the touch screen 11 displaying a Web page containing a news article “1 m giant eel caught!”.

The main control unit 20, as in step S103, extracts words of interest from the page data of the Web page while the Web page is being displayed on the touch screen 11 (S203).

Then, the main control unit 20, as in step S107, causes a list of interest orientations to be displayed on the touch screen 11 and prompts the user to select one of the interest orientations (S205). The user then selects one of the interest orientations by touching a desired interest orientation on the touch screen 11. For example, as illustrated in FIG. 8B, the display screen 30 of the touch screen 11 displays interest orientations “search”, “video”, “shopping”, “friend”, “registered word”, and “!?” that are pre-set and stored in the storage unit 26 as the interest orientation buttons 43. The user then selects one of the interest orientations by touching a desired one of the interest orientation buttons 43 with a finger on the touch screen 11.

The main control unit 20, with respect to each of the words of interest extracted in step S203, performs a Web search using a search site suitable for the interest orientation selected in step S205 (S207). Namely, the main control unit 20 transmits all of the words of interest extracted in step S203 to the search site suitable for the interest orientation selected in step S205 (such as the second interest orientation search server 4, which may include a search server that mainly searches video sites), thereby requesting the transmission of search results for each of the words of interest. The second interest orientation search server 4 conducts searches by using all of the received words of interest, extracts Web pages that contain the words of interest, and transmits a list of the Web pages to the portable telephone 1.

Upon reception of the Web page list by the portable telephone 1, the main control unit 20 causes the Web page list to be displayed on the touch screen 11, and prompts the user to select a view target Web page (S209). For example, as illustrated in FIG. 8C, the received Web page list includes Web pages “AAAA” and “BBBB”. The data of the Web pages and the words of interest used for searching the Web pages, such as “1 m” and “giant eel”, are displayed on the display screen 30 of the touch screen 11 in a Web page button 45. The user then selects a Web page by touching a desired Web page in the Web page button 45 on the touch screen 11. When a Web page is selected, the main control unit 20 receives the page data of the Web page from the content server 2 and displays the Web page on the touch screen 11.

For example, when the words “1 m” and “giant eel” are extracted in step S203 as the words of interest, and the user selected “video” in step S205 and the Web page “BBBB” after step S209, the portable telephone 1 acquires the page data of the Web page “BBBB” and causes the Web page to be displayed on the display screen 30 of the touch screen 11 in a search result screen 46, as illustrated in FIG. 8D. Thus, the portable telephone 1 displays the Web page list of the view targets on the touch screen 11 in a compact manner, so that the user can easily select a Web page by simply touching the touch screen 11.

Thus, the portable telephone 1 transmits extracted words of interest as the search words from a Web page to a search server corresponding to the interest orientation selected by the user, receives search results from the search server, and then displays the search results on the touch screen 11. The user then selects a desired Web site from the search results obtained based on the interest orientation selected by the user. Because the portable telephone 1 extracts search words while the user is viewing a Web page, the user can conduct a Web search by performing a reduced number of operations.

Thus, in accordance with the second embodiment, when a user wishes to conduct a Web search by using a word or phrase contained in a Web site the user is viewing, the user can conduct the Web search by simple operations.

### [c] Third Embodiment

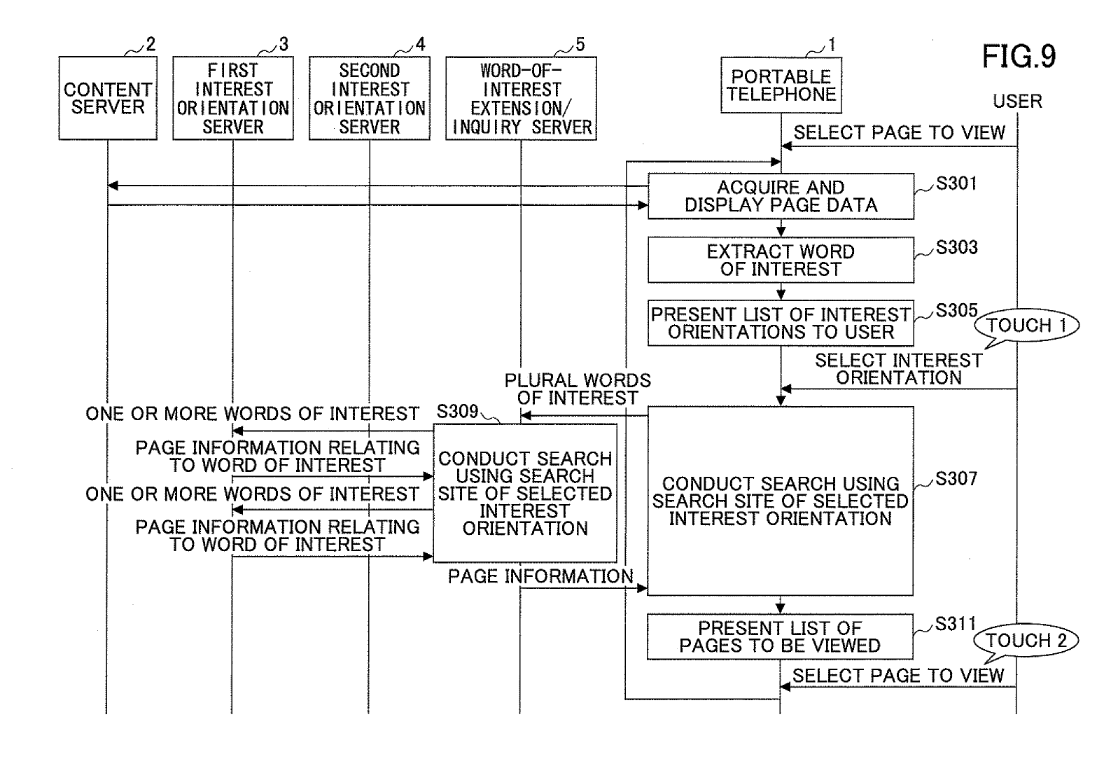

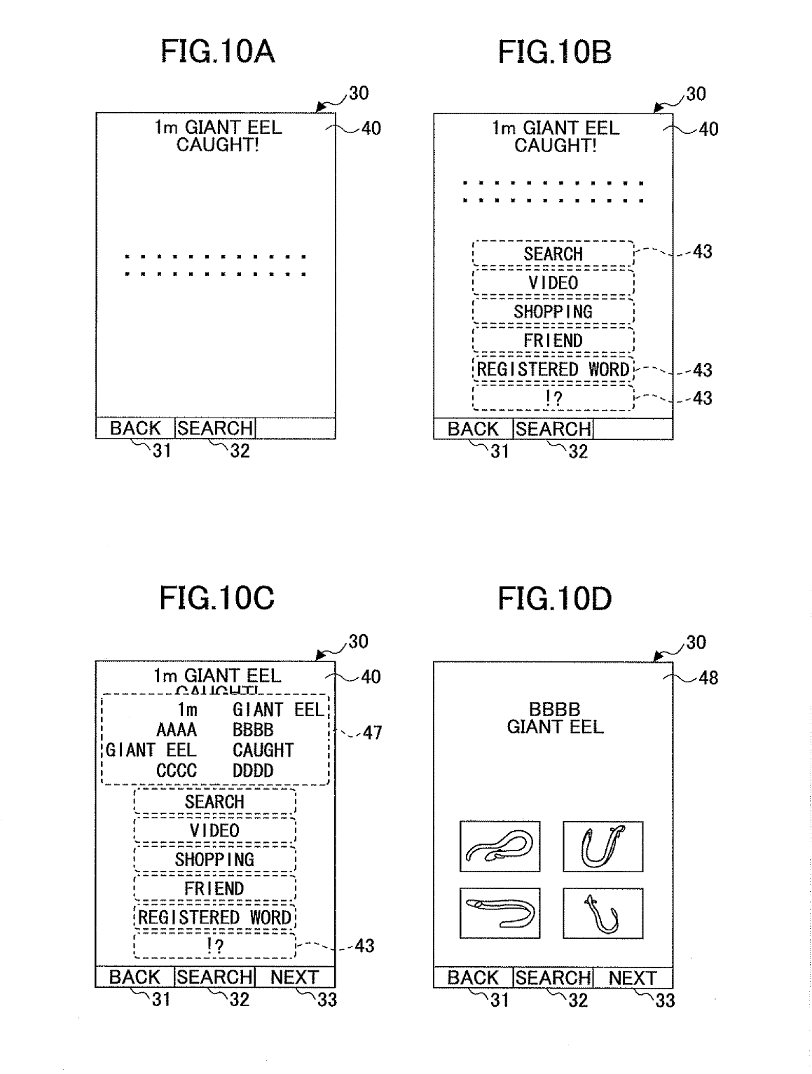

A portable terminal according to a third embodiment is described with reference to FIGS. 9 and 10. In the following, elements or functions similar to those of the first embodiment or the second embodiment are designated with similar reference numerals in order to omit redundant descriptions. The portable telephone 1 according to the third embodiment, which is an example of a portable terminal, may be applied in the same network system 100 illustrated in FIG. 1 as that of the first and second embodiments. The portable telephone 1 according to the third embodiment may have the same structure as that of the first and second embodiments, as illustrated in FIG. 2. Further, the portable telephone 1 according to the third embodiment may include the same units as those of the first and second embodiments illustrated in FIG. 3; namely, the main control unit 20, the power supply circuit unit 21, the operation input control unit 22, the display control unit 23, the voice control unit 24, the communication control unit 25, and the storage unit 26, which are connected by a bus so that they can communicate with one another

In accordance with the foregoing first and second embodiments, the portable telephone 1 sends a search request directly to a search site, such as the first interest orientation search site 3 or the second interest orientation search site 4. In accordance with the third embodiment, the portable telephone 1 sends a search request to the word-of-interest extension/inquiry server 5. The word-of-interest extension/inquiry server 5 requests a search server to conduct a search after extending the word of interest, for example. Because the search request to the search server is sent from the word-of-interest extension/inquiry server 5, the process time for Web search may be reduced and improved search performance may be obtained.

A Web search process performed by the portable telephone 1 according to the third embodiment is described with reference to a sequence diagram of FIG. 9 and FIGS. 10A through 10D illustrating the transition of screens on the touch screen of the portable telephone 1 during the Web search process.

First, the portable telephone 1 presents a list of Web pages as view targets to the user and prompts the user to select a desired Web page. When a Web page is selected by the user, the main control unit 20 transmits a transmit request for the page data of the selected Web page to the content server 2. The content server 2 transmits the requested page data to the portable telephone 1. The portable telephone 1 then receives the page data from the content server 2. The main control unit 20 causes the received page data to be displayed on the touch screen 11 (S301). For example, as illustrated in FIG. 10A, the Web viewing screen 40 is displayed in the display screen 30 on the touch screen 11 displaying a Web page containing a news article “1 m giant eel caught!”.

The main control unit 20, as in step S103, then extracts words of interest from the page data of the Web page while the Web page is being displayed on the touch screen 11 (S303).

The main control unit 20, as in step S107, causes a list of interest orientations to be displayed on the touch screen 11 and prompts the user to select an interest orientation (S305). The user selects an interest orientation by touching a desired interest orientation with a finger on the touch screen 11. For example, as illustrated in FIG. 10B, the display screen 30 of the touch screen 11 displays pre-set interest orientations “search”, “video”, “shopping”, “friend”, “registered word”, and “!?” stored in the storage unit 26 in advance, as interest orientation buttons 43. The user selects an interest orientation by touching a desired one of the interest orientation buttons 43 with a finger on the touch screen 11.

The main control unit 20 then requests the word-of-interest extension/inquiry server 5 to conduct a Web search with respect to the words of interest extracted in step S303 by using a search site suitable for the interest orientation selected in step S305 (S307). At this time, the portable telephone 1 transmits data indicating the extracted words of interest and the selected interest orientation to the word-of-interest extension/inquiry server 5.

The word-of-interest extension/inquiry server 5 may extend each of the words of interest received in step S307 as needed and then transmit the received (or extended) words of interest to the search site suitable for the interest orientation received in step S307 (such as the first interest orientation search server 3, which may include a search server that mainly searches shopping sites), thereby requesting the transmission of a search result for each of the words of interest (S309). The word-of-interest extension/inquiry server 5, when expanding a word of interest, may add another word of interest or narrow the interest orientation in view of the user's utilization history or profile information, or the current social conditions.

The first interest orientation search server 3, for example, conducts searches by using all of the received words of interest, extracts Web pages containing the words of interest, and transmits a list of the Web pages to the word-of-interest extension/inquiry server 5. The word-of-interest extension/inquiry server 5 receives the Web page list and transfers it to the portable telephone 1.

Upon reception of the Web page list from the word-of-interest extension/inquiry server 5, the main control unit 20 causes the Web page list to be displayed on the touch screen 11 and prompts the user to select a view target Web page (S311). For example, as illustrated in FIG. 10C, when the received Web page list includes Web pages “AAAA”, “BBBB”, “CCCC”, and “DDDD”, the data of the Web pages and the words of interest used for searching the Web pages, such as “1 m”, “giant eel”, and “caught”, are displayed on the display screen 30 of the touch screen 11 in a Web page button 47. The user selects a Web page by touching a desired Web page from the Web page button 47 on the touch screen 11. When a Web page is selected, the main control unit 20 receives the page data of the Web page from the content server 2 and displays the Web page on the touch screen 11.

For example, the words “1 m”, “giant eel”, and “caught” are extracted as words of interest in step S303, and the user selects “shopping” in step S307 and the Web page “BBBB” after step S311. In this case, the portable telephone 1 acquires the page data of the Web page “BBBB”, and causes the Web page to be displayed on the display screen 30 of the touch screen 11 as a search result screen 48, as illustrated in FIG. 10D. Thus, the portable telephone 1 displays the list of view target Web pages on the touch screen 11 in a compact manner, and the user can easily select a Web page by simply touching the touch screen 11.

Thus, when transmitting the words of interest extracted from the Web page as the search words to the search server corresponding to the interest orientation selected by the user, the portable telephone 1 extends the search words or narrows the interest orientation, receives the search results from the search server, and then displays the search results on the touch screen 11. The user then selects a desired Web site from the search results which are based on the interest orientation selected by the user. Thus, the user can conduct a Web search easily. By extending the search word or narrowing the interest orientation, a Web search can be conducted by reflecting the user's past state of use or preferences, or the current social conditions, while reducing the time for the Web search.

Thus, in accordance with the third embodiment, when a user wishes to conduct a Web search by using words or phrases contained in the Web site the user is viewing, the user can conduct the Web search by simple operations.

### [d] Fourth Embodiment

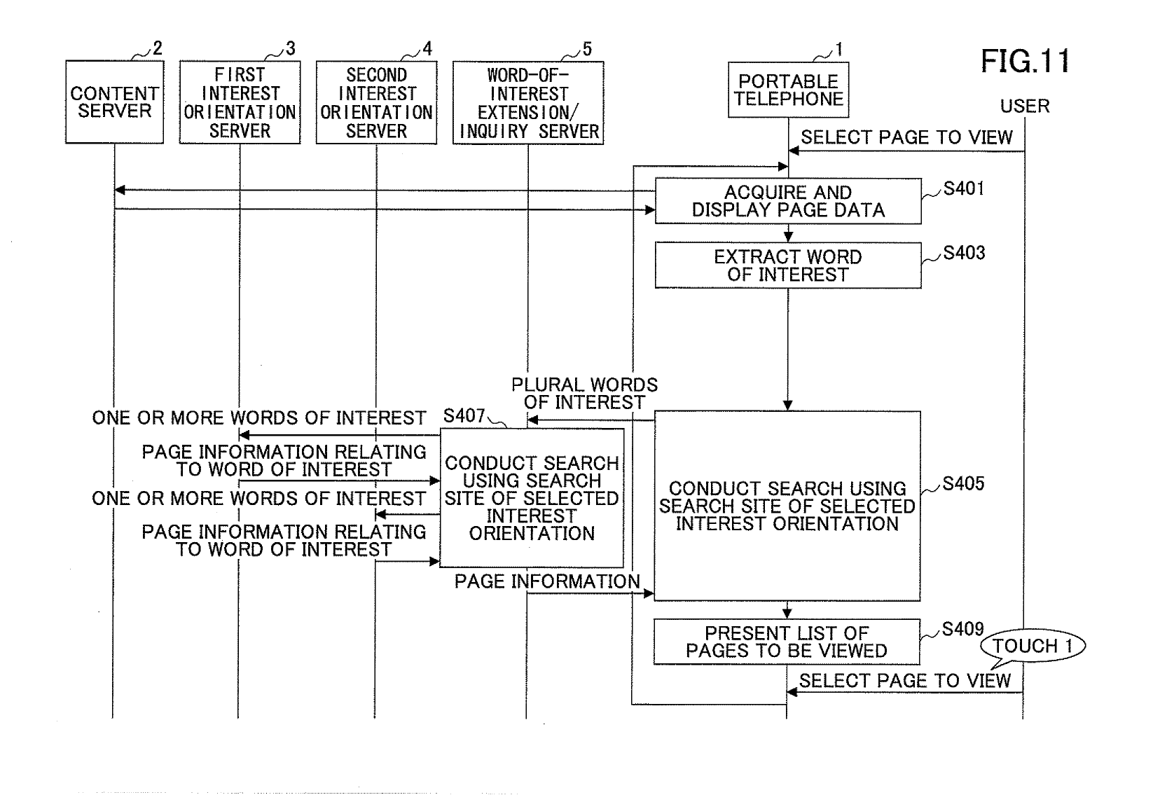

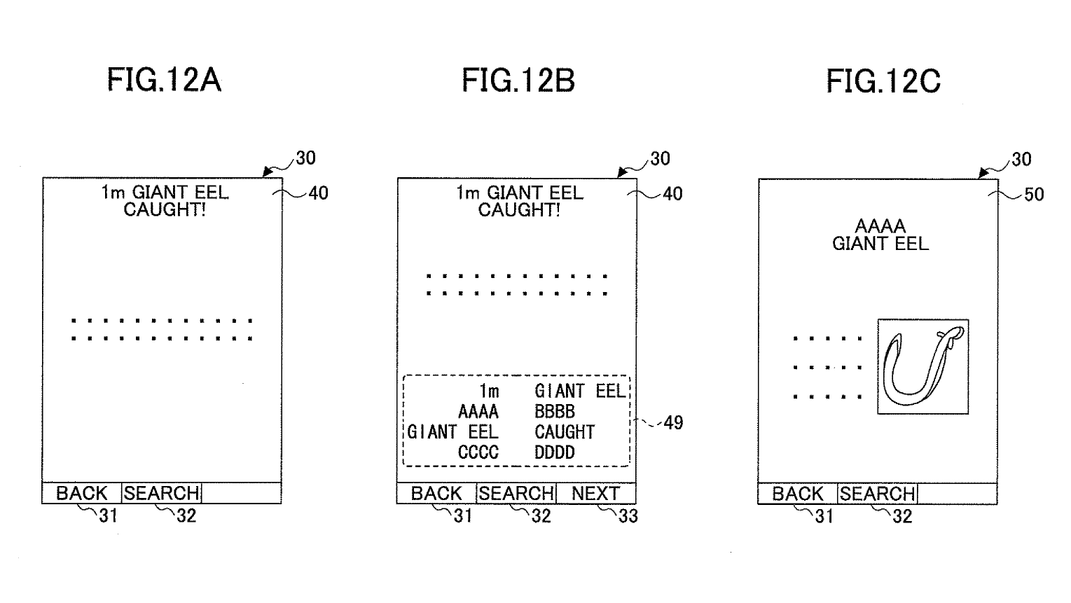

A portable terminal according to a fourth embodiment is described with reference to FIGS. 11 and 12. In the following, elements similar to those of the first through third embodiments are designated with similar reference numerals in order to omit redundant descriptions. The portable telephone 1, which is an example of a portable terminal, according to the fourth embodiment may be applied in the same network system 100 as those of the first through third embodiments, as described in FIG. 1. Further, the portable telephone 1 according to the fourth embodiment may have the same structure as those of the first through third embodiments, as illustrated in FIG. 2. Further, the portable telephone 1 according to the fourth embodiment may include the same units as those of the first through third embodiments illustrated in FIG. 3; namely, the main control unit 20, the power supply circuit unit 21, the operation input control unit 22, the display control unit 23, the voice control unit 24, the communication control unit 25, and the storage unit 26, which are connected by a bus so that they can communicate with one another.

In accordance with the first through third embodiments, the portable telephone 1 allows the user to select the interest orientation when conducting a Web search. In accordance with the fourth embodiment, the portable telephone 1 omits the selection of the interest orientation by the user. Instead, the portable telephone 1 conducts a Web search by using either all of interest orientations, an interest orientation narrowed by a predetermined condition, or a pre-set interest orientation in order to reduce the operational burden on the user.

A Web search process performed by the portable telephone 1 according to the fourth embodiment is described with reference to a sequence diagram of FIG. 11 and FIGS. 12A through 12C illustrating the transition of screens on the touch screen of the portable telephone 1 during the Web search process.

First, the portable telephone 1 presents a list of Web pages as view targets to the user and prompts the user to select a desired Web page. When the user selects a Web page, the main control unit 20 transmits a transmit request for the page data of the selected Web page to the content server 2. The content server 2 transmits the requested page data to the portable telephone 1. The portable telephone 1 receives the page data from the content server 2. The main control unit 20 displays the received page data on the touch screen 11 (S401). For example, as illustrated in FIG. 12A, the Web viewing screen 40 is displayed on the display screen 30 of the touch screen 11 displaying a Web page containing a news article “1 m giant eel caught!”, for example.

The main control unit 20, as in step S103, extracts words of interest from the page data of the Web page while the Web page is being displayed on the touch screen 11 (S403).

The main control unit 20 then requests the word-of-interest extension/inquiry server 5 to conduct a Web search for each of the words of interest extracted in step S403 by using a search site suitable for the pre-set interest orientation (S405). At this time, the portable telephone 1 transmits data indicating the words of interest and the interest orientation to the word-of-interest extension/inquiry server 5.

The word-of-interest extension/inquiry server 5 may extend the words of interest received in step S405 as needed, and then transmit the received (or extended) words of interest to plural search sites corresponding to the interest orientations (such as the first interest orientation search servers 3 and 4), thereby requesting the transmission of a search result for each of the words of interest (S407). The word-of-interest extension/inquiry server 5, when extending the words of interest, may add another word of interest or narrow the interest orientation by using the user's utilization history or profile information.

The plural search servers, such as the first interest orientation search servers 3 and 4, conduct searches by using all of the received words of interest, extract Web pages that contain the words of interest, and transmit a list of the Web pages to the word-of-interest extension/inquiry server 5. The word-of-interest extension/inquiry server 5 receives the Web page list and transfers it to the portable telephone 1.

Upon reception of the Web page list from the word-of-interest extension/inquiry server 5, the main control unit 20 causes the Web page list to be displayed on the touch screen 11 and prompts the user to select a view target Web page (S409). For example, as illustrated in FIG. 12B, when the received Web page list includes the Web pages “AAAA”, “BBBB”, “CCCC”, and “DDDD”, the data of the Web pages and the words of interest used for searching the Web pages, such as “1 m”, “giant eel”, and “caught”, are displayed on the display screen 30 of the touch screen 11 in a Web page button 49. The user then selects a Web page by touching a desired Web page with a finger in the Web page button 49 on the touch screen 11. When a Web page is selected, the main control unit 20 receives the page data of the Web page from the content server 2 and causes the Web page to be displayed on the touch screen 11.

For example, when the words “1 m”, “giant eel”, and “caught” are extracted in step S403 as the words of interest and the user selects the Web page “BBBB” after step S409, the portable telephone 1 acquires the page data of the Web page “BBBB” and causes the Web page to be displayed on the display screen 30 of the touch screen 11 as a search result screen 50, as illustrated in FIG. 12C. Thus, the portable telephone 1 can display the list of view target Web pages on the touch screen 11 in a compact manner, and the user can easily select a Web page by touching the touch screen 11.

Thus, the portable telephone 1 transmits the words of interest extracted from the Web page as search words to multiple search servers, receives search results for the words of interest from the search servers, and then displays the search results on the touch screen 11. The user can conduct a Web search easily by selecting a desired Web site from the search results. Further, by extending the search words or narrowing the interest orientation, the user's past state of use or preferences, or the current social conditions can be reflected in the Web search, while also reducing the time for Web search. Further, because the portable telephone 1 extracts search words while the user is viewing a Web page, the user can conduct a Web search through a reduced number of operations.

Preferably, an interest orientation for a Web search may be pre-set and stored in the storage unit 26 in the portable telephone 1, and a Web search may be conducted by using the pre-set interest orientation. The interest orientation may be set by the user by operating the operation keys 14, or the interest orientation used in the previous Web search may be stored in the storage unit 26. In this case, data indicating the pre-set interest orientation may be transmitted to the word-of-interest extension/inquiry server 5 in step S405, and the received (or extended) words of interest may be transmitted in step S407 to a search site suitable for the interest orientation received in step S405 (such as the first interest orientation search server 3), thereby requesting the transmission of search results.

In accordance with the fourth embodiment, when a user wishes to conduct a Web search by using a word or phrase contained in a Web site the user is viewing, the user can conduct a Web search by simple operations.

While embodiments of the present invention have been described with reference to the portable telephone 1, various embodiments may be realized by using any other communication terminals as long as the communication terminal includes a search unit for conducting a search via a network. Examples include a PHS (Personal Handyphone System), a PDA (Personal Digital Assistant), a MID (Mobile Internet Device), a portable music player, a portable video camera, and a portable game device.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A portable terminal comprising:
a word extracting unit configured to extract a word contained in data of a Web page being viewed;
a Web search request unit configured to transmit a search request to a search site with the word extracted by the word extracting unit as a search word and receive a list of Web pages that contain the search word from the search site as a search result; and
a display unit configured to display the search result received by the Web search request unit.

2. The portable terminal according to claim 1, further comprising:
an interest orientation selecting unit configured to select an interest orientation,
wherein the Web search request unit transmits the search request to the search site corresponding to the interest orientation selected by the interest orientation selecting unit.

3. The portable terminal according to claim 1, further comprising:
a search word selecting unit configured to select one of a plurality of the words extracted by the word extracting unit,
wherein the Web search request unit transmits the search request to the search site with the word selected by the search word selecting unit as the search word.

4. The portable terminal according to claim 1, further comprising:
a Web page selecting unit configured to select one of a plurality of the Web pages from the search result displayed by the display unit,
wherein the display unit acquires data of the Web page selected by the Web page selecting unit and displays the data.

5. The portable terminal according to claim 1, further comprising:
a setting unit configured to set the search site,
wherein the Web search request unit transmits the search request to the search site set by the setting unit.

6. The portable terminal according to claim 1, further comprising:
an extending unit configured to extend the word extracted by the word extracting unit,
wherein the Web search request unit transmits the search request to the search site with the word extended by the extending unit as the search word.

7. The portable terminal according to claim 1,
wherein the Web search request unit is configured to transmit the search request to a plurality of the search sites and receive the search result from the plural search sites.
